(19) United States
(12) Patent Application Publication
(10) Pub. No.: US 2006/0047398 A1
(43) Pub. Date: Mar. 2, 2006

(54) Power train system for vehicle

(75) Inventors: Tetsuya Abe, Nagoya (JP); Tsuneyuki Egami, Gamagoori-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/216,453

(22) Filed: Sep. 1, 2005

(30) Foreign Application Priority Data
Mar. 22, 2005 (JP) 2005-081208
Sep. 2, 2004 (JP) 2004-256010

(51) Int. Cl. G06F 17/00

(52) U.S. Cl. 701/69

(57) ABSTRACT

A power train system for a vehicle is disclosed, in which the vehicle is provided with front wheels and rear wheels, one of which are main drive wheels and the other of which are subsidiary drive wheels. The system comprises a first power source arranged to power the main drive wheels and a second power source arranged to power the subsidiary drive wheels. The system further comprises a wheel coupling shaft mechanically coupled with the subsidiary drive wheels and a power distribution device mechanically coupled with the wheel coupling shaft and the second power source to perform power distributions to and from the wheel coupling shaft.

### CROSS REFERENCE TO RELATED APPLICATIONS

The present application relates to and incorporates by reference Japanese Patent applications No. 2004-256010 filed on Sep. 2, 2004 and No. 2005-081208 filed on Mar. 22, 2005.

### BACKGROUND OF THE INVENTION

1. Field of the Invention

The present invention relates to a power train system for a vehicle wherein power sources are mounted for front and rear wheels of a vehicle, respectively, to enable the vehicle to run with resulting powers.

2. Description of the Related Art

In the related art, a large number of proposals have heretofore been made to provide a vehicle system that includes an engine and a motor generator as power sources of a vehicle to allow the vehicle to run with at least either one of resulting powers. For instance, Japanese Patent Provisional Publication No. 11-147424 discloses a structure, wherein a motor generator is connected to a crankshaft of an engine and an auxiliary unit (also, called “accessory), such as an air-conditioning compressor, is mechanically connected to a rotary shaft of the motor generator, which when the motor generator drives the auxiliary unit with the engine stopped in operation, a clutch is uncoupled to disconnect the crankshaft and the motor generator. By so doing, the auxiliary unit is made possible to be driven with minimum electric power. With such a structure, however, the auxiliary unit and associated power cut-off mechanism are mounted on a periphery of the engine, making a peripheral structure of the engine cumbersome and complicated. Also, considering a structure wherein the respective component parts are installed in a limited installation space around the engine, inconvenience may occur with the resultant difficulty in mounting those component parts.

Further, another attempt has been proposed, as shown in for instance Japanese Patent Provisional Publication No. 05-260610, to provide a method by which a motor generator operates to recover deceleration energy of a vehicle for conversion to electric energy. However, since the existing system takes the form of a structure wherein energy is collected via a transmission connected to an engine output shaft, causing issues with deterioration in efficiency of collecting energy.

### SUMMARY OF THE INVENTION

It is therefore an object of the present invention to provide a power train system for a vehicle, which is excellent in vehicle mounting capabilities of power sources and an auxiliary unit (accessory) and which is able to efficiently recover energy during a deceleration state and other states of a vehicle.

According to the present invention, a motor generator and an auxiliary unit are connected to a vehicle wheel shaft, mechanically connected to subsidiary drive wheels of a vehicle, via a power distribution device. With a four-wheel vehicle, the motor generator and the auxiliary unit may be mechanically connected to a coupling shaft (corresponding to a vehicle-wheel coupling shaft) of a differential gear, disposed between left and right wheels, via a power distribution device. The auxiliary unit may include an air-conditioning compressor. The motor generator and the auxiliary unit may be integrated as a vehicular auxiliary unit.

With such a structure, during running of the vehicle propelled by a power source mounted in an area closer to main drive wheels, the motor generator and the auxiliary unit are caused to operate with power transferred from the vehicle-wheel coupling shaft of subsidiary drive wheels. This allows the air-conditioning unit, etc., to operate. As the vehicle undergoes deceleration or the like, the motor generator operates with power delivered from the vehicle-wheel coupling shaft to regenerate electric power. Further, during a stop in running of the vehicle, power of the motor generator enables the operation of the auxiliary unit (for operating an air-conditioning unit or the like). Furthermore, by transferring power, resulting from the motor generator, to the subsidiary drive wheels via the power distribution device and the vehicle-wheel coupling shaft, the vehicle is enabled to run in a mode with only power from the motor generator or to run in another mode (four-wheel drive running mode in a four-wheel drive vehicle) in cooperation with a power source mounted on an area closer to the main drive wheels.

The structure mentioned above has excellent advantages described below. During a regeneration mode with the occurrence of deceleration, or the like, of the vehicle, power, transferred from the vehicle-wheel coupling shaft, is delivered to the motor generator without intervening the transmission, enabling regenerative energy to be efficiently recovered. Further, since the auxiliary unit is mounted with the motor generator in areas closer to the subsidiary drive wheels, a peripheral structure of the power source (such as engine, etc.), provided in the area closer to the main drive wheels, can be simplified. This results in improvement over mounting capabilities of the power sources and the auxiliary unit.

Further, the present invention takes the form of a structure wherein power generating devices are provided for the front wheels and rear wheels of the vehicle, respectively. That is, the first power generating device is mounted in an area closer to either one of the front wheels and the rear wheels and includes an internal combustion engine, playing a role as a power source, and an electric power generator that is rotated with an output shaft of the internal combustion engine for generating electric power. The second power generating device is mounted in an area closer to the wheels different from those, to which the first power generating device is close, and includes a power converter electrically connected to the motor generator playing a role as a power source, the auxiliary unit, the power distribution device and the motor generator for converting electric power from direct current to alternating current and vice versa. In addition, an electric storage device stores electric power, generated by the electric power generator, and the motor generator. In particular, the motor generator and the auxiliary device are mechanically connected to the vehicle-wheel coupling shaft, which permits the rotations of the wheels for which the second power generating device is mounted, via the power distribution device

With the structure set forth above, during running of the vehicle with power coming from the internal combustion engine (first power generating device), the motor generator and the auxiliary unit are caused to operate with power delivered from the vehicle-wheel coupling shaft closer to the vehicle wheels opposing to the internal combustion engine. This enables the air-conditioning unit, etc., to be operated. Then, as the vehicle undergoes deceleration, the motor generator is driven with power from the vehicle-wheel coupling shaft to regenerate electric power. Further, during a stop in running of the vehicle, the auxiliary unit is enabled to operate with power of the motor generator (for operating the air-conditioning unit). Furthermore, power, generated by the motor generator, is transferred to the vehicle wheels via the power distribution device and the vehicle-wheel coupling shaft, making it possible to establish a vehicle running mode with only power from the motor generator or another vehicle running mode (four-wheel drive running mode in a four-wheel drive vehicle) in cooperation with power from the internal combustion engine.

With the structure mentioned above, power from the vehicle-wheel coupling shaft is transferred to the motor generator without intervening the transmission during a regeneration mode accompanied by deceleration of the vehicle, enabling regenerative energy to be efficiently recovered. Also, the auxiliary unit is provided with the motor generator in the area opposing to the internal combustion, enabling the simplification of a peripheral structure of the internal combustion engine. This results in improvement over mounting capabilities of the power sources and the auxiliary unit.

By using the planetary gear to mechanically connect the vehicle-wheel coupling shaft, the motor generator and the auxiliary unit, power distributions among these component parts can be simply realized. This enables a system structure to be simplified.

In this connection, Japanese Patent Provisional Publication No. 2004-168176 of the related art takes the form of a structure that includes a vehicle shaft clutch and gear reduction unit provided in mid-course of a power delivery path for the purpose of transferring or interrupting power to be delivered to drive wheels from a motor and further includes an air-conditioning compressor disposed between the motor and the vehicle shaft clutch. With such a related art, power (rotation) is transferred with a certain gear ratio and the rotational speed of the air-conditioning compressor is raised or lowered depending on a rotational speed of the vehicle speed coupling shaft. Therefore, restrictions have been caused in control of the rotational speed of the compressor. On the contrary, with the structure employing the planet gear set as the power distribution device in a manner as mentioned above, the rotational speed of the compressor can be controlled without depending upon the rotational speed of the vehicle-wheel coupling shaft, making it possible to optimally control the relevant rotational speed.

When using the planetary gear set as the power distribution device, the vehicle-wheel coupling shaft, the motor generator and the auxiliary unit shaft may be connected to the ring gear, the sun gear and the carrier in respective combinations. However, combinations in connection may be arbitrarily determined.

A switchover device may be provided for achieving switchover between a coupled state and an uncoupled state of at least either two of the vehicle-wheel coupling shaft, the motor generator and the auxiliary unit shaft. In this case, suitably disconnecting the respective coupling states through the use of the switchover device enables a power delivery path to be appropriately managed.

With the structure provided with the switchover device between the vehicle-wheel coupling shaft and the auxiliary unit shaft for achieving switchover between the coupled state and the uncoupled state between these component parts, in particular, the switchover device may be brought into the uncoupled state during the stop in running of the vehicle while rendering the switchover device operative to be coupled in response to a request in another way. This enables power transfer to be reliably performed from the motor generator to the auxiliary unit during the halt of the vehicle. Further, during a start of the vehicle, the switchover device is brought into the coupled state in order to reliably perform the power transfer from the motor generator to the vehicle-wheel coupling shaft. The switchover device may be selectively operated such that during running of the vehicle, the switchover device is uncoupled to allow the motor generator to operate the auxiliary unit or the switchover device is coupled to allow power to be transferred from the vehicle wheel shaft to the auxiliary unit.

It is conceivable that the auxiliary unit is comprised of an air-conditioning compressor to allow the same to be used for constructing a refrigeration cycle. Under such a situation, an expander may be disposed in mid-course of a coolant passage, through which coolant flows, to expand coolant in reduced pressure while converting expansion energy to mechanical energy for recovery of energy for thereby permitting the resulting mechanical energy, recovered with the expander, to operate the compressor and the motor generator. This allows mechanical energy, collected with the expander, to assist the operations of the compressor and the motor generator, resulting in improvement over operating efficiencies of these component parts.

A heat recovery device may be disposed in the coolant flow passage at a position upstream of the expander for collecting waste heats. This allows the improvement over an energy recovery efficiency of the expander.

### BRIEF DESCRIPTION OF THE DRAWINGS

In the accompanying drawings:

FIG. 1 is a view showing a schematic structure of a vehicle system of a first embodiment according to the present invention;

FIG. 2 is a view showing a structure of a vehicle auxiliary unit;

FIG. 3 is a view showing a schematic structure of a vehicle system of a second embodiment;

FIG. 4 is a view showing a schematic structure of a vehicle system of a third embodiment;

FIG. 5 is a view showing a structure of a subsidiary power block;

FIG. 6 is a view showing a list of drive modes of a vehicle;

FIG. 7 is a flowchart showing a drive control routine of the vehicle; and

FIG. 8 is a flowchart showing a calculation routine of a vehicle drive torque.

### DETAILED DESCRIPTION OF PREFERRED EMBODIMENTS

Referring to the accompanying drawings, various embodiments according to the present invention will now be described.

### First Embodiment

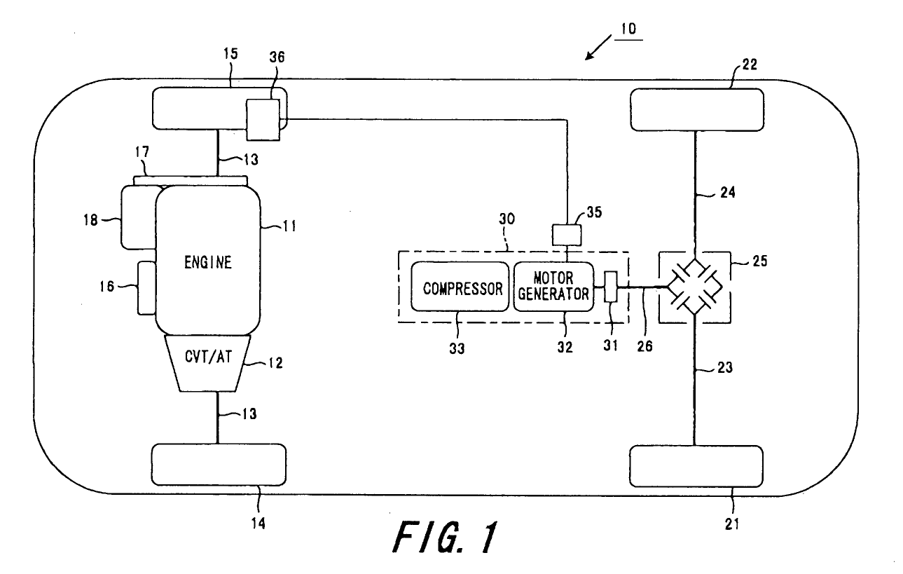

A first embodiment according to the present invention will now be described below with reference to the accompanying drawings. The present embodiment is described in conjunction with an exemplary wherein the presently filed embodiment is concretized in a so-called hybrid vehicle, which takes the form of a power drive source including an engine and an electric motor, to run with either one of resulting powers. FIG. 1 is a view showing a schematic structure of a vehicle system of the presently filed embodiment. In addition, in FIG. 1, the left and right sides of the drawing represent the front and rear of a vehicle, respectively.

In FIG. 1, a vehicle 10 includes a front section in which an engine 11, playing a role as a power drive source, and a transmission 12, composed of a CVT (Continuously Variable Transmission) and an AT (Automatic Power Transmission), etc., are connected in series to allow an output of the engine 11 to be transmitted to axles 13 via the transmission 12, resulting in rotations of left and right front wheels 14, 15. Mounted on the engine 11 is a starter motor 16 that plays a role as a starter. An alternator 18 is coupled to an output shaft of the engine 11 via a coupling device 17 such as a belt or the like.

Further, a rear section of the vehicle 10 carries a differential gear 25, disposed between axles 23, 24 coupled to left and right rear wheels 21, 22, respectively, to which a vehicle auxiliary unit 30 is connected via a drive shaft 26. The vehicle auxiliary unit 30 is comprised of a planetary gear set 31, playing a role as a power transfer device, an motor generator 32 serving as a power source, and an air-conditioning compressor 33 playing a role as an auxiliary unit. The motor generator 32, which is formed of, for instance, a motor generator of an alternating current with synchronous type, combines a function (power running function) of an electric motor supplied with electric power to be driven and a function (regenerative function) of an electric power generator with which mechanical energy is converted to electric energy. The motor generator 32 is connected to a battery 36 via an inverter 35.

The vehicle 10 runs mainly with engine power and the front wheels correspond to main drive wheels. In the meanwhile, the vehicle 10 is able to run with power of the motor generator and the rear wheels correspond to subsidiary drive wheels. In this case, the engine 11 and the motor generator 32 may be referred to as a main power source and a subsidiary power source, respectively.

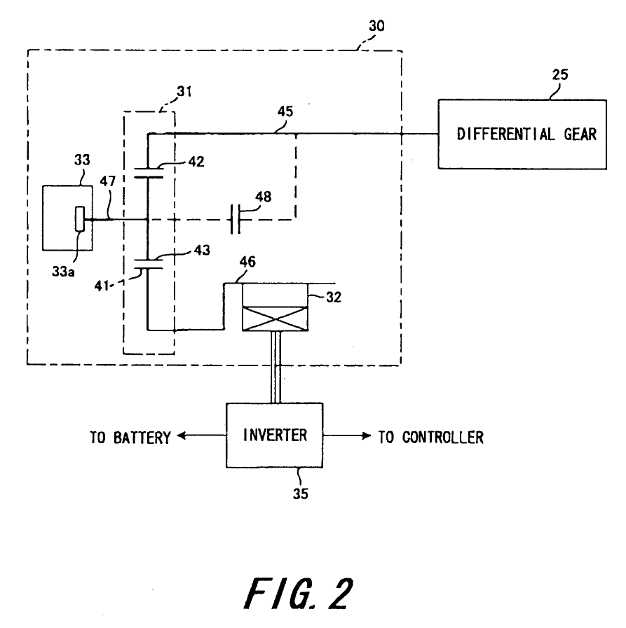

A detailed structure of the vehicle auxiliary unit 30 is described with reference to a typical view of FIG. 2. In FIG. 2, the planetary gear set 31 is comprised of a sun gear 41 and a ring gear 42, which rote about a central axis with respect to each other, and a carrier 43 that carries pinion gears orbiting and rotating in mesh with the sun gear 41 and the ring gear 42. A differential-gear coupling shaft 45 (identical to the drive shaft 26) is connected to the ring gear 42 and a motor-generator coupling shaft 46 is connected to the sun gear 41. A compressor coupling shaft 47 is connected to the carrier 43.

Further, a clutch 48 is disposed between the differential-gear coupling shaft 45 and the compressor coupling shaft 47 and operative such that under a clutch-ON state (coupled condition), power is directly transferred from the differential-gear coupling shaft 45 to the compressor 33 and under a clutch-OFF state (uncoupled condition), no power is directly transferred from the differential-gear coupling shaft 45 to the compressor 33. A compressor clutch 33a is incorporated in the compressor 33 and coupled or uncoupled depending on a state of an air-conditioner switch (not shown).

A large number of controllers (ECUs) are installed in the vehicle 10 for controlling a variety of vehicle component parts. Thus, for instance, an engine ECU controls the engine 11; a transmission ECU controls the transmission 12; and a motor ECU controls the inverter 35 for the motor generator.

With a vehicle system formed in such a structure, the motor generator 32 and the compressor 33 are caused to operate in response to power inputted from the differential-gear coupling shaft 45. This enables the operation of an air conditioner or the like. During deceleration of the vehicle, the motor generator 32 plays a role as an electric power generator that regenerates electric power in response to power delivered from the differential-gear coupling shaft 45, with resulting electric power being charged into the battery 36 via the inverter 35. Further, during a halt in running, or the like, of the vehicle the compressor 33 is driven with power delivered from the motor generator 32. Furthermore, power, generated by the motor generator 32, is transferred to the differential gear 25 via the planetary gear set 31 and further delivered to the left and right rear wheels 21, 22, thereby rendering the vehicle operative to run in a mode with only power from the motor generator 32 or in another mode (four-wheel drive mode) in cooperation with power from the engine 11.

Now, operating conditions of the vehicle 10 under various situations are described below. First, under normal running of the vehicle 10, the vehicle 10 basically runs with power of the engine 11. When this takes place, the clutch 48 is uncoupled to disconnect the differential-gear coupling shaft 45 and the compressor coupling shaft 47 from each other whereby power, inputted to the planetary gear set 31 via the differential gear 25, is distributed in supply to the motor generator 32 and the air-conditioning compressor 33 with a given distribution ratio. This allows the motor generator 32 and the air-conditioning compressor 33 to operate. Under such a status, if the air-conditioner switch is turned on, then, the clutch 33a inside the compressor 33 is coupled to rotate a drive shaft inside the compressor. This renders the air conditioner to be operative. Moreover, if the air-conditioner switch is turned off, the clutch 33a inside the compressor 33 is uncoupled (under an interruptive state), thereby rendering the air conditioner inoperative.

Further, during running of the vehicle, a drive state is selected depending on the rotation of the differential-gear coupling shaft 45 from between an uncoupled status of the clutch 48, wherein the compressor 33 operates with power of the motor generator 32, and a coupled status of the clutch 48 wherein power is transferred from the differential-gear coupling shaft 45 to the compressor 33.

During running of the vehicle, if the vehicle undergoes deceleration or braked condition, the motor generator 32 regenerates braking energy into electric power that in turn is charged into the battery 36. When this takes place, power, delivered from the differential gear 25, is transferred to the motor generator 32 without intervening through the transmission, thereby enabling regenerative energy to be efficiently collected.

During running of the vehicle on a low μ-road, such as a snowy road or an ice-up road or the like, if slippages of the vehicle wheels are detected, the vehicle is rendered operative to be driven under the four-wheel drive condition wherein running power includes, in addition to engine power, power delivered from the motor generator 32. Under such a condition, power outputted from the motor generator 32 is transferred to the left and right rear wheels 21, 22 via the differential gear 25.

During a halt of the vehicle, the engine 11 is stopped due to a so-called idling-stop function (automatic stop with restart function). When this takes place, the clutch 48 is uncoupled, causing power of the motor generator 32 to operate the compressor 33. Under such a condition, if the air-conditioner switch is turned on, the clutch 33a is coupled, rendering the air conditioning unit operative. Even in the absence of the idling-stop, the clutch 48 is uncoupled during the halt of the vehicle (under the idling condition), thereby causing power of the motor generator 32 to drive the compressor 33.

During a start of the vehicle subsequent to the halted condition, the clutch 48 is brought into a coupled condition in order to allow power to be reliably delivered from the motor generator 32 to the differential gear 25 and the compressor 33. This enables the vehicle 10 to rapidly start. However, under circumstances where no need arises for the vehicle 10 to be assisted with power of the motor generator 23 during the start of the vehicle, the clutch 48 is uncoupled.

With the presently filed embodiment set forth above in detail, advantageous effects result in as described below.

The presently filed embodiment has been described in connection with the form of a structure wherein the motor generator 32 and the air-conditioning compressor 33 are mechanically connected to the differential-gear coupling shaft 45, closer to the drive wheels (rear wheels) different from the drive wheels to which the engine 11, playing a role as the main drive power source, is close, via the planetary gear set 31. In contrast to the existing system wherein regenerative energy is collected via the transmission, to which the engine 11 is connected, during a regenerative state followed by deceleration, or the like, of a vehicle, the structure of the presently filed embodiment enables power, delivered from the differential-gear coupling shaft 45, to be directly transferred to the motor generator 32, thereby enabling regenerative power to be efficiently collected. Further, due to a structure wherein the compressor 33 is disposed, together with the motor generator 32, on a rear side of the vehicle in opposition to the vehicle front on which the engine 11 is mounted, a peripheral structure of the engine 11 can be simplified. Therefore, mounting capabilities of the power source and the auxiliary units are highly improved.

Due to the provision of the differential-gear coupling shaft 45, the motor-generator coupling shaft 46 and the compressor coupling shaft 47 that are mechanically connected to each other via the planetary gear set 31, power distributions among these various component parts can be simply realized. Accordingly, a system structure can be realized in compactness. Moreover, with such a structure in which the planetary gear set is employed, a rotational speed of the compressor can be controlled regardless of a rotational speed of a vehicle-wheel coupling shaft (differential-gear coupling shaft 45), enabling the rotational speed of the compressor to be optimally controlled.

Due to a structure wherein the clutch 48 is disposed between the motor-generator coupling shaft 46 and the compressor coupling shaft 47 to allow the clutch 48 to be uncoupled during running of the vehicle and coupled during a halt of the vehicle, a drive path can be reliably realized both in a power delivery path, in which power is transferred from the differential-gear coupling shaft 45 to the compressor coupling shaft 47 during running of the vehicle, and in another power delivery path in which power is transferred from the motor-generator coupling shaft 46 to the compressor coupling shaft 47 during the halt of the vehicle. This enables the compressor 33 to appropriately operate under a status such as an idling-stop condition.

### Second Embodiment

A second embodiment takes the form of a structure wherein an expander, by which coolant expands in reduced pressure to convert expansion energy into mechanical energy upon recovery, is disposed in mid-course of a coolant passage through which coolant (such as, for instance, carbon dioxide) flows to allow mechanical energy, recovered from the expander, to be used for driving the compressor and the motor generator.

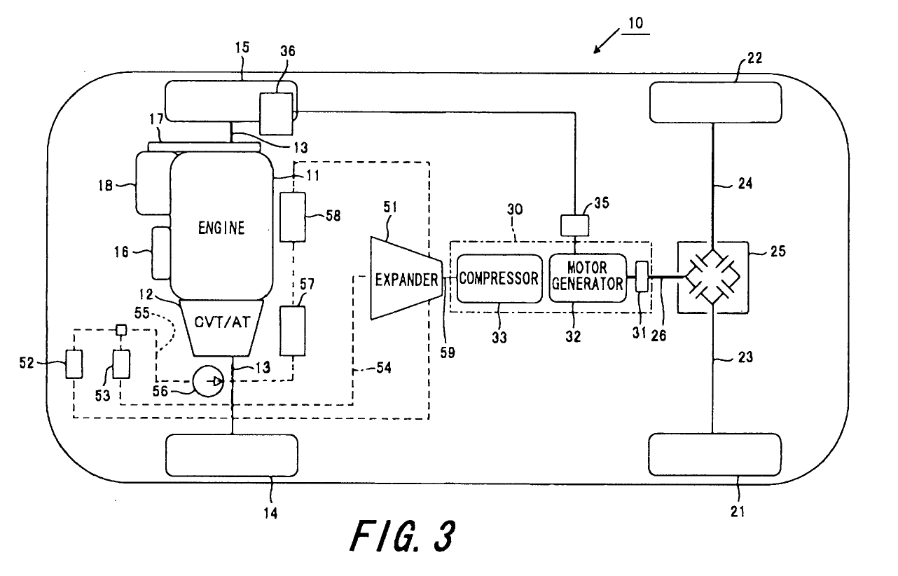

FIG. 3 shows a vehicle system of the second embodiment, which differs from that of FIG. 1 in that the vehicle additionally incorporates a coolant circulation circuit (in refrigeration cycle) for a vehicle air-conditioning unit. Also, the compressor 33, by which coolant is compressed, is of the nature, which is disposed in the mid-course of a coolant delivery pipe 54, and shown as the vehicle auxiliary unit 30 together with the motor generator 32 for the sake of convenience as in FIG. 1.

With a structure shown in FIG. 3, the expander 51, an evaporator (vaporizer) 52 and a condenser 53 are connected to each other through the coolant delivery pipe 54. During basic operations, coolant, flowing through the coolant delivery pipe 54, is expanded in the expander 51 from a liquefied state into a misty state with low temperatures and low pressures, upon which misty coolant is fed to the evaporator 52. With the evaporator 52, latent heat, needed for evaporation, is released from ambient air along with vaporization of coolant, thereby cooling ambient air (i.e., for cooling a vehicle compartment). Further, coolant, vaporized in the evaporator 52, is condensed in the condenser 53 for delivery to the expander 51.

Coolant also circulates through a coolant delivery pipe 55 in a path, represented by a coolant pump 56→a water coolant heat exchanger 57→a waste heat recovery unit 58→the expander 51. When this takes place, the water coolant heat exchanger 57 develops heat exchange between coolant, flowing through the coolant delivery pipe 55, and coolant water circulating through the engine 11. Also, the waste heat recovery unit 58 collects waste heat from the engine 11. The expander 51 is mechanically connected to the compressor 33 via a coupling shaft 59 and operative to expand coolant under reduced pressure to convert expansion energy to mechanical energy upon recovery for permitting resulting mechanical energy to drive the compressor 33 and the motor generator 32.

Now, operating conditions of the vehicle 10 under various situations are described. Under such situations, the associated component parts operate during an idling-stop condition (during a halt of the vehicle) in a mode different that of the first embodiment. That is, during the idling-stop of the vehicle, the clutch 48 is coupled to allow power of the motor generator 32 to operate the compressor 33. In conjunction with such power, the compressor 33 is assisted with power supplied from the expansion 51 via the coupling shaft 59. Under such a condition, if the air-conditioner switch is turned on, then, the clutch 48 is coupled, rendering the air conditioning unit operative. This similarly applies to idling operation of the engine 11.

As set forth above, since the second embodiment takes the form of a structure wherein the compressor 33 and the motor generator 32 are rendered operative with mechanical energy recovered with the expander 51, operating efficiencies of these component parts are improved. Further, due to the provision of the heat recovery device, such as the water coolant heat exchanger 57 and the waste heat recovery unit 58, disposed in the coolant delivery pipe 55 upstream of the expander 51, the expander 51 is able to have improved efficiency of collecting energy.

### Third Embodiment

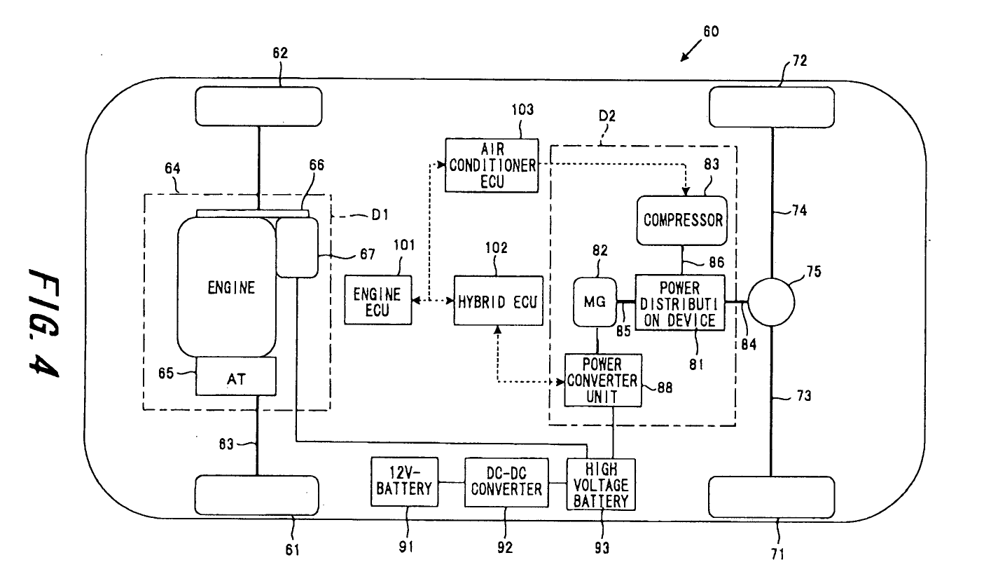

Now, a vehicle system of a third embodiment is described. FIG. 4 is a view showing a schematic structure of the vehicle system of the presently filed embodiment. Also, in FIG. 4, a left side represents a front of a vehicle and a right side represents a rear of the vehicle.

In FIG. 4, two power generation devices are incorporated in back and forth areas of a vehicle 60 and a main power block D1 is mounted in an area closer to front wheels as a first power generation device and a subsidiary power block D2 is installed in an area closer to rear wheels as a second power generation device. The vehicle 60 runs with powers created by these two power blocks D1, D2.

In particular, the vehicle 60 has a front section, provided with two left and right front wheels 61, 62 as main drive wheels, and the main power block D1 is coupled to axles 63 to which the front wheels 61, 62 are connected. The main power block D1 is comprised of an engine 64, playing a role as a main power source to which fuel, such as gasoline or diesel oil, etc., is supplied for combustion with air to generate power, and a transmission 65 composed of an AT (Automatic Transmission), etc., with an output of the engine 64 being delivered to the axles 63 via the transmission 65 for thereby rotating the left and right front wheels 61, 62. An alternator 67, playing a role as an electric power generator, is connected to an output shaft of the engine 64 via a coupling device 66 such as a belt or the like.

The vehicle 60 also has a rear section, provided with two left and right rear wheels 71, 72 serving as subsidiary drive wheels, which are connected to axles 73, 74 between which a differential gear 75 is disposed. A subsidiary power block D2 is coupled to the differential gear via a drive shaft 84. The subsidiary power block D2 is comprised of a power distribution device 81, composed of a planetary gear set, a motor generator 82 playing a role as a subsidiary power source, and an air-conditioning compressor 83 (merely referred to as a compressor hereunder) serving as an auxiliary unit. The motor generator 82 is coupled to the power distribution device 81 via a drive shaft 85. The motor generator 82 includes, for instance, a motor generator of an alternating current with synchronous type that combines a function (power running function) of an electric motor driven with electric power and a function (regenerative function) of an electric power generator by which mechanical energy is converted to electric energy. The motor generator 82 is connected to a power converter unit 88 composed of an inverter or the like.

Also, as used herein, “three drive shafts 84 to 86”, connected to the power distribution device (planetary gear set) 81, are referred to such that the drive shaft 84 is referred to as a “differential-coupling shaft 84”; the drive shaft 85 is referred to as an “magnetic-generator (MG) coupling shaft 85”; and the drive shaft 86 is referred to as a “compressor coupling shaft 86”.

An electric power system takes the form of a structure that includes a battery 91 with a rating of 12V, a DC-DC converter 92 by which a step-down circuit and a step-up circuit are formed, and a high voltage battery 93, playing a role as an electric storage device, which is connected to an alternator 67 of the main power block D1 and the power converter unit 88 of the subsidiary power block D2.

Further, the vehicle system of the presently filed embodiment includes a variety of electronic controllers (ECUs), which controllably drive actuators, etc., based on detected values of various sensors that are not shown. More particularly, an engine ECU 101 forms an engine controller that executes engine control, such as fuel injection control and ignition timing control, based on engine operating conditions on case-by-case basis. A hybrid ECU 102 forms a vehicle controller that totally controls the vehicle 60 as a whole and outputs control signals to the electric power converter unit 88 that controls the drive or the electric power generating state of the motor generator 82. An air-conditioner ECU 103, forming an air-conditioner controller, drives the compressor 83 based on a request inputted by a driver and a running state, or the like, for thereby executing air-conditioning control. These ECUs 101 to 103 are principally composed of a well-known microcomputer, composed of a CPU, a ROM and a RAM, respectively, to be operative to perform the transmission and receiving of data or the like with respect to each other.

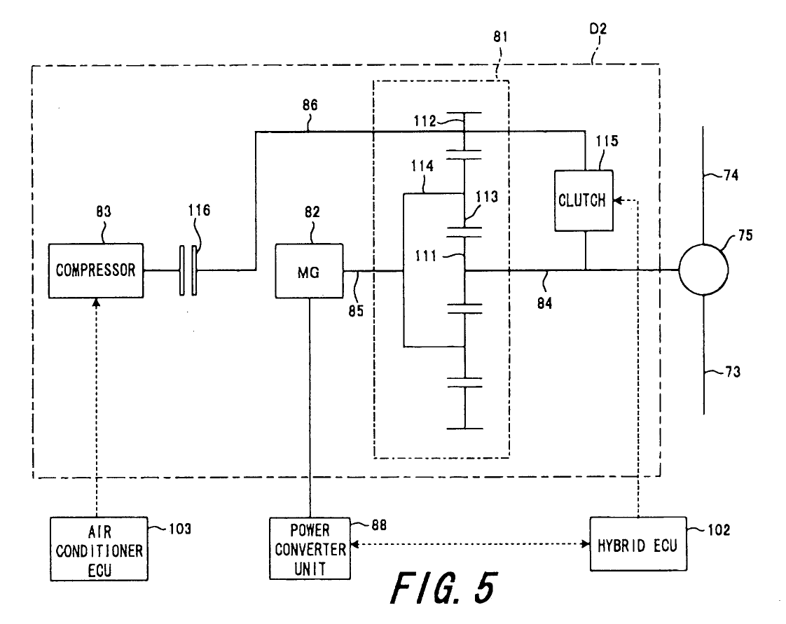

A detailed structure of the subsidiary power block D2 is described below with reference to a typical view of FIG. 5. In FIG. 5, the power distribution device (planetary gear set) 81 is comprised of a sun gear 111 and a ring gear 112, which rote about a central axis with respect to each other, and a carrier 114 that carries pinion gears orbiting and rotating in mesh with the sun gear 111 and the ring gear 112. A differential-coupling shaft 84 is connected to the sun gear 111; a compressor coupling shaft 86 is connected to the ring gear 112; and a magnetic-generator coupling shaft 85 is connected to the carrier 114.

Further, a direct-coupling clutch 115 is disposed between the differential-coupling shaft 84 and the compressor coupling shaft 86. The direct-coupling clutch 115 is comprised of, for instance, a clutch of an ON/OFF switchover type that is responsive to a command from the hybrid ECU 102 to be switched over between ON/OFF (coupling or uncoupling) states. However, the switchover device may include the other device such as a one-way clutch or a centrifugal switch, etc.

When the direct-coupling clutch 115 is coupled, power is transferred to the compressor 83 from the differential-coupling shaft 84 via the compressor coupling shaft 86. When this takes place, the three shafts (the differential-coupling shaft 84, the Magnetic-generator coupling shaft 85 and the compressor coupling shaft 86) of the power distribution device 81 are caused to rotate at the same speed. On the contrary, with the direct-coupling clutch 115 uncoupled, the differential-coupling shaft 84 and the compressor coupling shaft 86 are brought into a disconnected condition and the three shafts of the power distribution device 81 are caused to rotate at speeds based on collinear characteristics of the planetary gear set, respectively.

A compressor clutch 116 is disposed on the compressor coupling shaft 86 and coupled or uncoupled depending on states or the like of the air-conditioner switch (not shown). In actual practice, the compressor clutch 116 is integrally formed with the compressor 83 and coupled or uncoupled in response to a command outputted to the compressor 83 from the air-conditioner ECU 103.

With the vehicle system set forth above, the motor generator 82 and the compressor 83 are caused to operate with power transferred from the differential-coupling shaft 84. This enables the air conditioning unit, etc., to operate. During deceleration or the like of the vehicle, the motor generator 82 is driven with power transferred from the differential-coupling shaft 84 to regenerate electric power, causing resulting electric power to be charged into the battery via the power converter unit 88. Further, during a halt in running of the vehicle, the compressor 83 is enabled to operate with power of the motor generator 82. Furthermore, power, generated by the motor generator 82, is transferred to the differential gear 75 via the power distribution device 81 and further delivered to the left and right rear wheels 71, 72, enabling the vehicle to run with only power of the motor generator 82 or the vehicle to run in cooperation with power of the engine 64.

With the structure set forth above, the vehicle 60 has capabilities of achieving a two-wheel drive running (2WD running) mode in which the vehicle runs with either power of the engine 64 or power of the motor generator 82 and a four-wheel drive running (4WD running) mode in which the vehicle runs with both powers of the engine 64 and the motor generator 82.

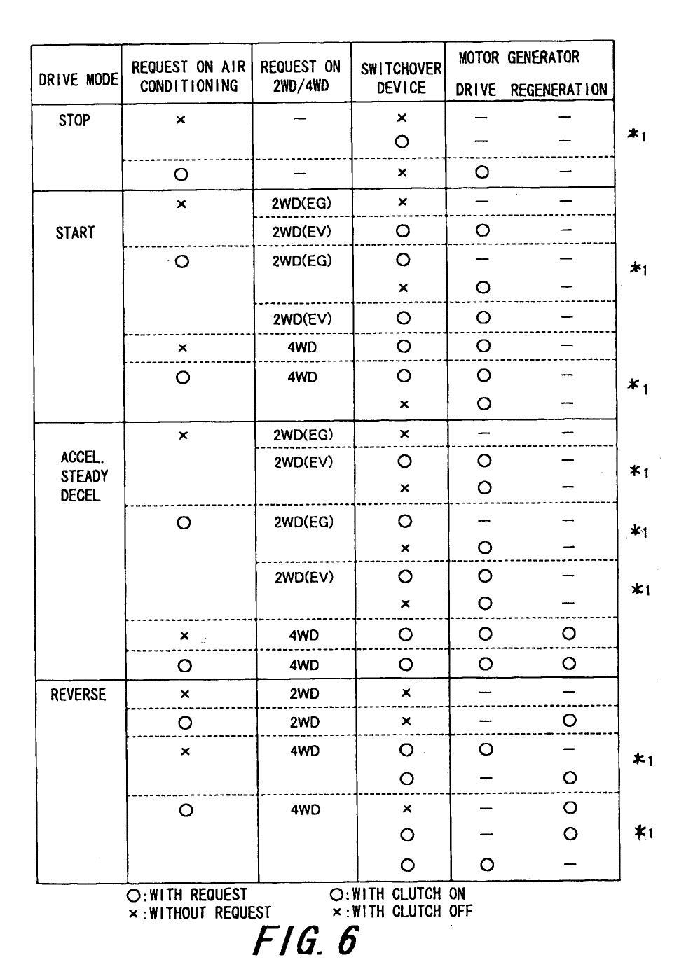

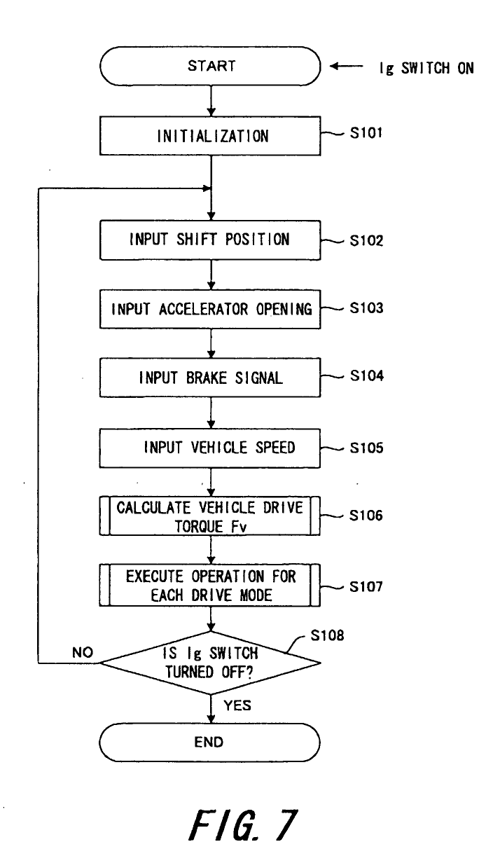

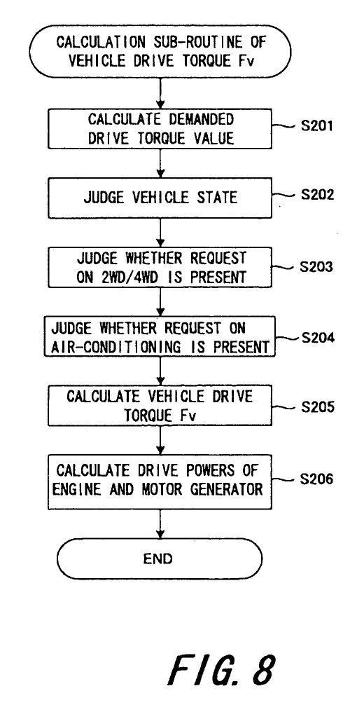

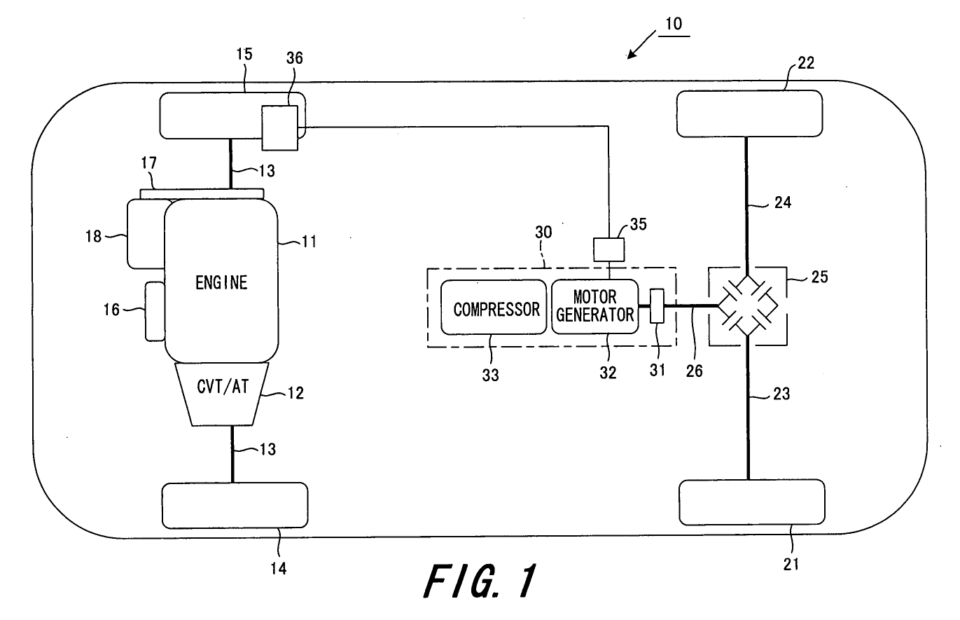

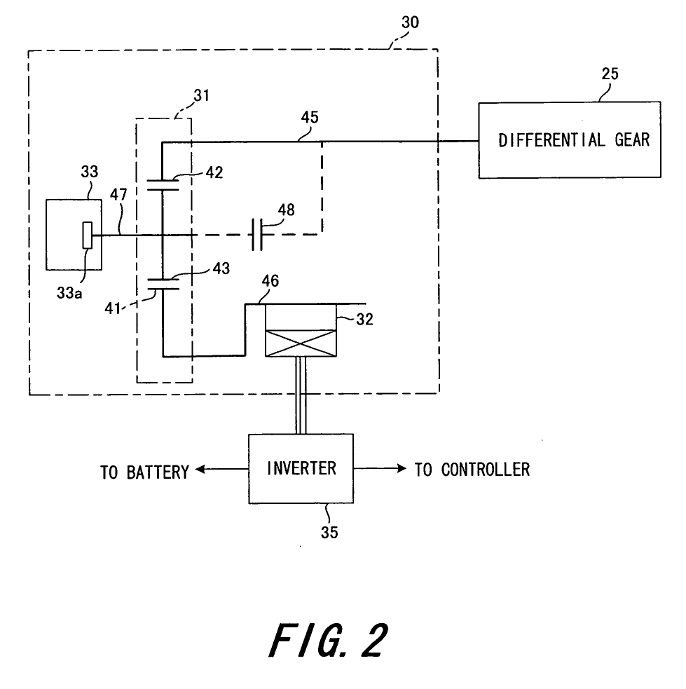

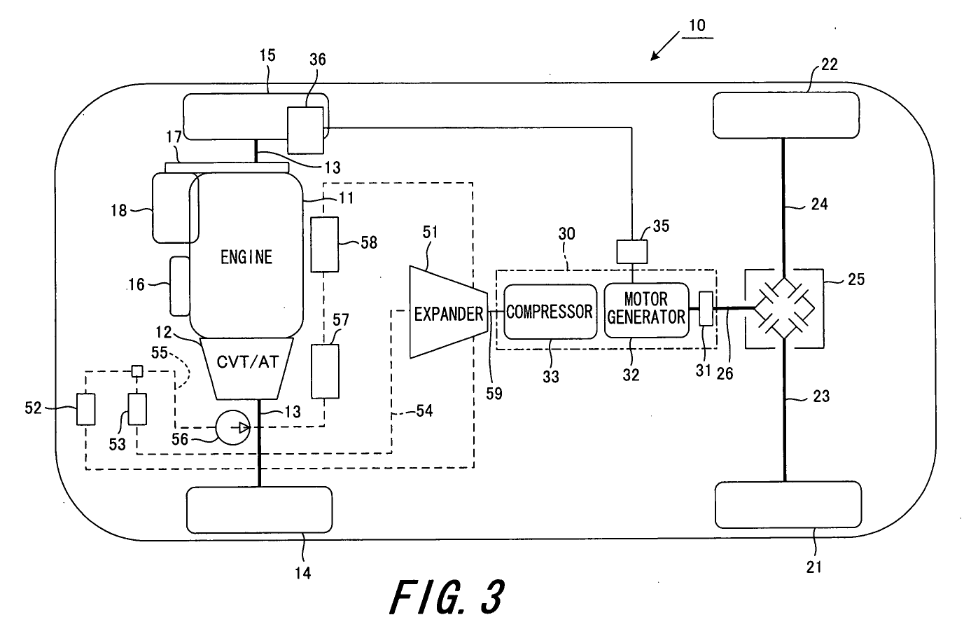

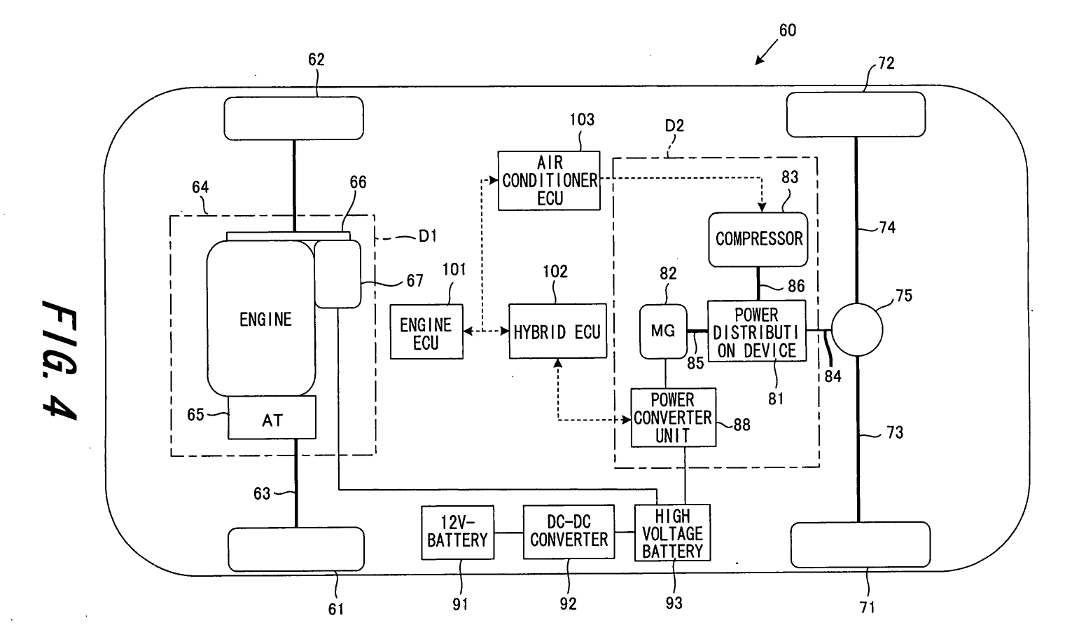

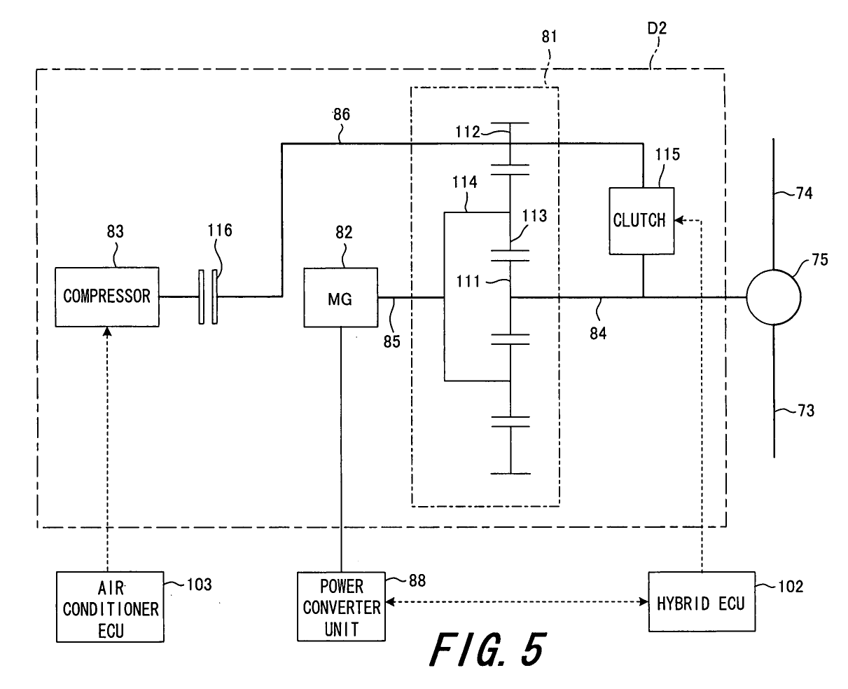

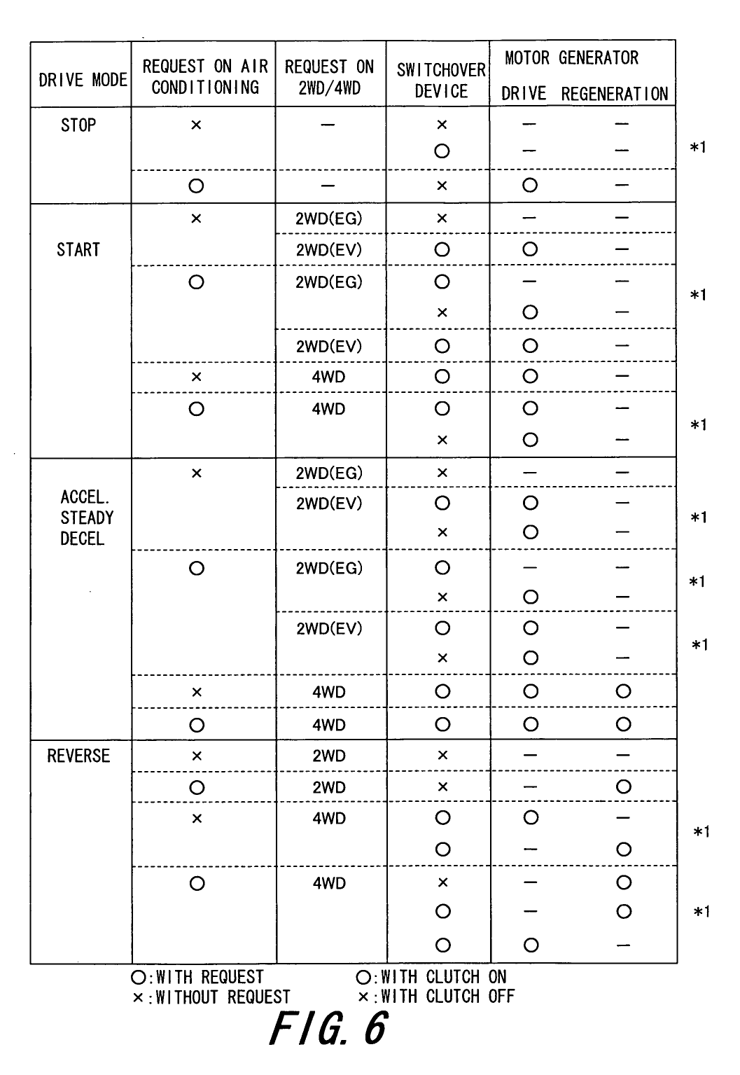

Operating conditions under various states of the vehicle 60 will now be described. FIG. 6 is a view showing a list of drive modes of the vehicle 60. Also, in FIG. 6, notation “2WD (EG)” refers to a 2WD running mode effectuated with engine power and notation “2WD (EV)” refers to a 2WD running mode effectuated with power of the motor generator 82.

As shown in FIG. 6, the drive modes of the vehicle 60 are classified broadly into (1) a halt mode, (2) a start mode, (3) an acceleration/steady/deceleration mode and (4) a reverse mode. In this case, the direct-coupling clutch 115 (switchover device) is coupled or uncoupled in response to a request on air-conditioning or a request on 2WD/4WD, etc., and the motor generator 82 is controlled under a driving or regenerative condition. Also, depending on a request on acceleration made by a driver, a powering condition and air-conditioning conditions, etc., the coupling state of the direct-coupling clutch 115 and the driving/regenerating states of the motor generator 82 are suitably altered even in the presence of the identical request on air-conditioning and the identical request on 2WD/4WD drive (see *1 in FIG. 6).

Now, description is made of one example of operations of the drive modes set forth above. For instance, it is supposed that the request on air-conditioning and the request on 2WD (EG) are present at the start mode. In such a case, at the beginning of the request on air-conditioning, the direct-coupling clutch 115 is uncoupled and the motor generator 82 is brought into a drive condition. This allows the rotational speed of the compressor 83 to increase with power of the motor generator 82 during which time a cooling capacity is exhibited at a maximum. Thereafter, as the rotational speed of the compressor reaches a rotational speed on request, the direct-coupling clutch 115 is coupled and the drive of the motor generator 82 is interrupted. This allows the three shafts of the power distribution device 81 to rotate at equal speeds, resulting in continuous rotation of the compressor 83 due to the rotation of the differential-coupling shaft 84 driven by the engine.

During deceleration and braking conditions, the motor generator 82 recovers braking energy, with resulting energy being charged into the high voltage battery 93 via the power converter unit 88. When this takes place, power is transferred from the differential gear 75 to the motor generator 82 without the intervention of the transmission, enabling regenerative energy to be efficiently collected.

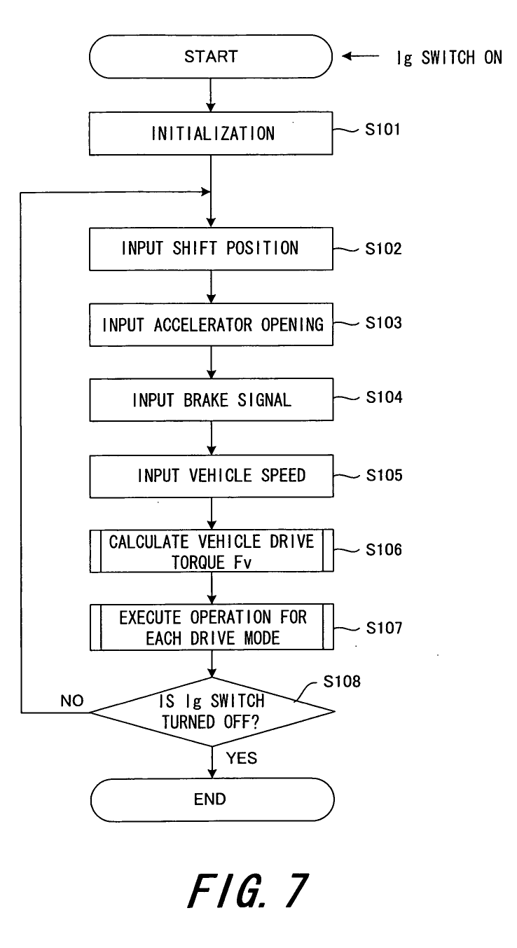

Now, description is made of drive control operation to be executed by the hybrid ECU 102. FIG. 7 is a flowchart showing a drive control routine of the vehicle 60 and the current routine is executed upon turning-on operation of the ignition switch.

In FIG. 7, first in step S101, initializations are executed to initialize an input and output port and set variable ranges of the RAM. Then, the operation is executed to read input values applied from various sensors, etc. That is, in step S102, a shift position signal for the transmission is inputted; an accelerator-opening signal is inputted in step S103; a braking signal is inputted in step S104; and a vehicle speed signal is inputted in step S105.

Subsequently, a vehicle drive torque Fv is calculated in step S106 and in consecutive step S107, operation is executed for each drive mode. When this takes place, the statuses of the direct-coupling clutch 115 and the motor generator 32 are controlled depending on the request on air-conditioning and the request on 2WD/4WD on the case-by-case basis.

In step S108, discrimination is made whether or not the ignition switch is turned off. If the ignition switch remains turned-on intact, the operation is routed back to step S102 to repeatedly execute the various operations, as set forth above, and if the ignition switch is turned off, the current routine is terminated.

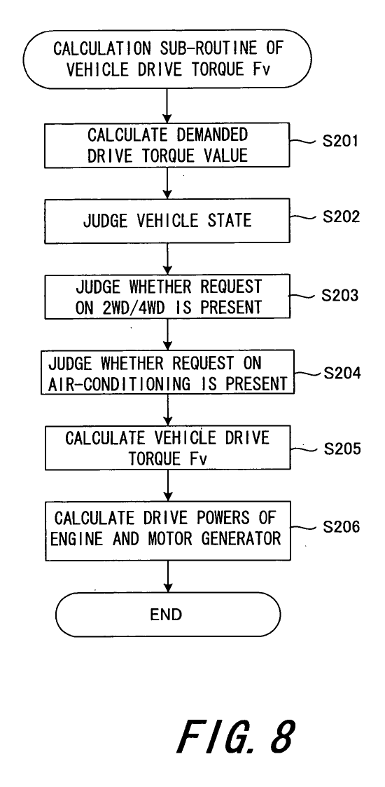

Next, description is made of a computation sub-routine of the vehicle drive torque Fv to be executed in step S106, mentioned above, with reference to FIG. 8.

In FIG. 8, in step S201, a drive torque (drive torque demand value), requested by a driver, is calculated based on an accelerator opening (or throttle opening may be available) or the like. In step S202, a vehicle condition is judged on case-by-case basis. When this takes place, the vehicle conditions may include the shift position of the transmission, running conditions such as stop/acceleration/deceleration/steady running, operating conditions of an accelerator pedal and a brake pedal, a status of a power supply, etc.

Further, in step S203, discrimination is made to find which of the 2WD running mode or 4WD running mode is currently requested based on the vehicle conditions or the like mentioned above. In step S204, the presence of a request on air-conditioning is judged based on operating conditions of the air-conditioner switch, manipulated by the driver, and vehicle compartment temperatures, etc.

Thereafter, in step S205, the vehicle drive torque Fv is calculated based on a demanded drive torque value and various requests, etc. and in consecutive step S206, respective drive powers of the engine 64 and the motor generator 82 are calculated based on the status (battery residue capacity) or the like.

With the third embodiment set forth above, due to a capability of transferring power from the differential-coupling shaft 84 to the motor generator 82 during regeneration with the vehicle deceleration, etc., in contrast to the existing system wherein regenerative energy is collected via the transmission connected to the engine, regenerative energy can be collected in an efficient manner. Further, the motor generator 82 and the compressor 83 are located in the rear area of the vehicle in combination in contrast to the existing system wherein the engine 64 is installed in the front of the vehicle, enabling the simplification of peripheral structures of the engine 64. Therefore, this results in improvement over installation capabilities of the power source and auxiliary units.

Since the differential-coupling shaft 84, the Magnetic-generator coupling shaft 85 and the compressor coupling shaft 86 are mechanically connected to each other through the power distribution device 81 composed of the planetary gear set, power distributions among these component parts can be simply realized. Therefore, the simplification of the system structure can be realized. Also, with the structure employing the planetary gear set, the rotational speed of the compressor can be controlled regardless of the rotational speed of the vehicle coupling shaft (differential-coupling shaft 84), thereby making it possible to optimally control the rotational speed of the compressor.

Also, the present invention is not limited to the contents described with reference to the embodiments, set forth above, and may be implemented in a manner, for instance, described below.

While the first and second embodiments have been described with reference to an exemplary structure wherein the clutch 48 is disposed between the differential-gear coupling shaft 45 and the compressor coupling shaft 47 and coupled or uncoupled depending on the vehicle running conditions, such a structure may be replaced with a structure wherein the clutch is disposed between the motor-generator coupling shaft 46 and the compressor coupling shaft 47 or a structure wherein the clutch is disposed between the differential-gear coupling shaft 45 and the motor-generator coupling shaft 46. Even with any of such structures, power transfer can be favorably achieved.

While the first and second embodiments have been described with reference to an exemplary structure wherein the differential-gear coupling shaft 45 (vehicle-wheel coupling shaft) is connected to the ring gear 42 of the planetary gear set 31 and the motor-generator coupling shaft 46 (motor generator shaft) is connected to the sun gear 41 while the compressor coupling shaft 47 (auxiliary unit shaft) is connected to the carrier 43, combinations in connection among those component parts may be altered. That is, the vehicle-wheel coupling shaft, the motor generator shaft and the auxiliary unit shaft may be connected to the ring gear, the sun gear and the carrier, respectively, in arbitrary combinations.

While the third embodiment have been described with reference to an exemplary structure wherein the differential-coupling shaft 84 (vehicle-wheel coupling shaft) is connected to the sun gear 111 of the power distribution device (planetary gear set) 81 and the compressor coupling shaft 86 (auxiliary unit shaft) is connected to the ring gear 112 while the Magnetic-generator coupling shaft 85 (motor generator shaft) is connected to the carrier 114, combinations in connection of these component parts may be altered. That is, the vehicle-wheel coupling shaft, the motor generator shaft and the auxiliary unit shaft may be connected to the sun gear 111, the ring gear 112 and the carrier 114, respectively, in arbitrary combinations.

While the vehicles 10, 60 of the embodiments have been described with reference to a structure wherein the front wheels are caused to serve as main drive wheels and the rear wheels are caused to serve as the subsidiary drive wheels, the main and subsidiary drive wheels may be located in positions opposite to those mentioned above.

Further, the main power source to be mounted for the main drive wheels may be comprised of a power source other than the engine. For instance, the main power source may be comprised of an electric motor.

While the presently filed embodiments have been described above with reference to a structure wherein due to the structure of the vehicle running mainly with engine power, the main power source is composed of the engine and the subsidiary power source is composed of the motor generator, the present invention is not limited to such a structure. It may be structured such that the main power source includes the motor generator and the subsidiary power source includes the engine.

The auxiliary unit is not limited to the air-conditioning unit mentioned above and may take the form of, for instance, a hydraulic pump of a power steering device. In this case, the power steering hydraulic pump is connected to the auxiliary unit shaft of the power distribution device (planetary gear set).

The present invention may be embodied in several other forms without departing from the spirit thereof. The embodiments and modifications described so far are therefore intended to be only illustrative and not restrictive, since the scope of the present invention is defined by the appended claims rather than by the description preceding them. All changes that fall within the metes and bounds of the claims, or equivalents of such metes and bounds, are therefore intended to be embraced by the claims.

What is claimed is:

1. A power train system for a vehicle with front wheels and rear wheels one of which are main drive wheels and the other of which are subsidiary drive wheels, the system comprising:
a first power source arranged to power the main drive wheels;
a second power source arranged to power the subsidiary drive wheels;
a wheel coupling shaft mechanically coupled with the subsidiary drive wheels; and
a power distribution device mechanically coupled with the wheel coupling shaft and the second power source to perform power distributions to and from the wheel coupling shaft.

2. The system according to claim 1, wherein the second power source included a motor generator and an auxiliary unit both mounted on the vehicle, both the motor generator and the auxiliary unit being mechanically coupled with the power distribution device to receive controlled drive power therefrom, respectively.

3. The system according to claim 1, further a differential gear coupled with a gear drive shaft intervenes in the wheel coupling shaft
wherein the power distribution device is mechanically coupled with the gear drive shaft couple with the differential gear.

4. The system according to claim 1, further a clutch controlling operations of the power distribution device; and
control means controlling the clutch depending on information indicative of running states of operated states of the vehicle.

5. The system according to claim 1, wherein the auxiliary unit is a compressor for an air conditioner mounted on the vehicle.

6. The system according to claim 1, wherein the auxiliary unit is a compressor for an air conditioner to which a conduit delivering coolant is connected,
the system further comprising an expander intervenes in the conduit to not only expand the coolant which is liquefied under a reduced pressure but also collect energy causing in the expansion, the collected energy being used to operate both the compressor and the motor generator.

7. The system according to claim 6, further comprising a waste heat collection unit collecting waste energy from the first source is arranged at a position of the conduit which is than the expander in the conduit.

8. A power train system for a vehicle with front wheels and rear wheels, the system comprising:
a first power generating apparatus arranged to provide a drive power to first wheels consisting of ones of the front wheels and the rear wheels, the first power generating apparatus including an internal combustion engine having an output shaft and being arranged to generate the drive power from the output shaft and a generator coupled with the output shaft so as to generate an electric power;
a second power generating apparatus arranged to provide a drive power to second wheels consisting of the others of the front wheels and the rear wheels via a wheel coupling shaft, the power generating apparatus including a motor generator generating a drive power, an auxiliary unit, a power distribution device, and a power conversion unit electrically connected with the motor generator so as to convert an AC power generated by the motor generator to a corresponding DC power, both the motor generator and the auxiliary unit being mechanically coupled with the wheel coupling shaft via the power distribution device; and
a storage in which the electric power generated by the generator in the first power generating apparatus and the motor generator in the second power generating apparatus.

9. The system according to claim 8, wherein the power distribution device is a planetary gear set having a ring gear, a sun gear and a carrier.

10. The system according to claim 9, wherein the ring gear, the sun gear, and the carrier are coupled with the wheel coupling shaft, a shaft coupled with the motor generator, and a shaft coupled with the auxiliary unit in a selected combination.

11. The system according to claim 10, further comprising switchover means switching at least any two shafts of the wheel coupling shaft, the shaft coupled with the motor generator, and the shaft coupled with the auxiliary unit so as to be coupled or de-coupled with each other.

12. The system according to claim 11, further comprising control means controlling the switchover means depending on information indicative of running states of operated states of the vehicle.

13. The system according to claim 10, wherein the switchover means is a clutch intervening between the wheel coupling shaft and the shaft coupled with the auxiliary unit so as to be coupled or de-coupled with each other.

14. The system according to claim 13, further comprising control means controlling the clutch depending on information indicative of running states of operated states of the vehicle.

15. The system according to claim 14, wherein the control means is configured to control the clutch so that the clutch is de-coupled during a stop of run of the vehicle and the clutch is coupled on demands when the vehicle is in states other than the stop of the run.
